(19) United States
(12) Patent Application Publication
(10) Pub. No.: US 2024/0169963 A1
(43) Pub. Date: May 23, 2024

(54) OPERATION INPUT DEVICE AND ELECTRONIC MUSICAL INSTRUMENT

(71) Applicant: InstaChord Corp., Tokyo (JP)

(72) Inventor: Yuichi NAGATA, Meguro-ku, Tokyo (JP)

(21) Appl. No.: 18/551,083

(22) PCT Filed: Mar. 19, 2021
(86) PCT No.: PCT/JP2021/011332

§ 371 Date: Sep. 18, 2023

(51) Int. Cl. G10H 1/34

(52) U.S. Cl. CPC G10H 1/342

(57) ABSTRACT

An operation input device used for an electronic musical instrument includes: a casing having a plurality of elongated holes arranged such that long sides thereof have a prescribed interval therebetween; a plurality of operating pieces respectively inserted in the plurality of elongated holes and held by the casing in a state in which distal-end side wall surfaces thereof protrude from the casing; an elastic support member having a front surface that supports proximal-end side wall surfaces and a back surface on which multiple projections are provided in positions corresponding to the proximal-end side wall surfaces; multiple pressure-sensitive electroconductive members respectively pressed by multiple projections to be elastically deformed; a substrate having multiple electrode patterns respectively contacting the multiple pressure-sensitive electroconductive members; and a spacer member disposed between the elastic support member and the substrate and having a plurality of openings arranged so as to avoid respective projections.

### CROSS-REFERENCE TO RELATED APPLICATIONS

The present application is a National Phase of International Application No. PCT/JP2021/011332 filed Mar. 19, 2021.

### TECHNICAL FIELD

The present invention relates to an operation input device and an electronic musical instrument.

### BACKGROUND ART

There is conventionally known an electronic musical instrument capable of inputting thereto a strumming operation with respect to an operating piece corresponding to guitar strings. For example, Patent Document 1 discloses strumming information input device having a flexible operating piece whose one end is fixed and the other end protrudes to a side opposite to the one end, a plurality of contact patterns provided on both sides in the operation direction of the input device at a predetermined interval from the operating piece, and a plurality of contact portions provided, corresponding respectively to the contact patterns, at positions on both sides of the operating piece.

### CITATION LIST

### Patent Document

Patent Document 1: JP 06-308962 A

### DISCLOSURE OF THE INVENTION

### Problems to be Solved by the Invention

In the strumming information input device disclosed in Patent Document 1, a plurality of contact patterns and a plurality of contact portions are provided on both sides of one operating piece in the operation direction. Thus, the number of components is large, and the structure is complicated. This disadvantageously increases manufacturing cost and reduces maintainability.

Further, the strumming information input device disclosed in Patent Document 1 cannot detect a small operation amount at a level that does not make a contact between the contact portions and contact patterns even when the operating piece is operated in the operation direction. Furthermore, the strumming information input device disclosed in Patent Document 1 can detect an operation to the operating piece with the contact patterns and contact portions when the operating piece is operated in the operation direction; while it cannot detect an operation in such a manner that the operating piece is struck or pressed from above, for example. As described above, the operation amount and operation direction to be detected as a playing operation are thus limited, so that the strumming information input device disclosed in Patent Document 1 cannot sufficiently support various playing operations.

The present invention has been made in view of the above problems, and an object thereof is to provide an operation input device and an electronic musical instrument which are capable of improving operability of a playing operation with a simple structure and an electronic musical instrument.

### Means for Solving the Problems

To solve the above problems, an operation input device according to one embodiment of the present invention is an operation input device used for an electronic musical instrument and includes: a casing having a plurality of elongated holes arranged such that long sides thereof have a prescribed interval therebetween; a plurality of operating pieces respectively inserted in the plurality of elongated holes and held by the casing so as to be operable in a short side direction of each of the elongated holes and the insertion direction in a state in which distal-end side wall surfaces thereof protrude from the casing; an elastic support member made of an elastic material having a predetermined thickness and having a front surface that supports proximal-end side wall surfaces of the plurality of operating pieces and a back surface on which a plurality of projections are provided in positions corresponding to the proximal-end side wall surfaces of the plurality of operating pieces; a plurality of pressure-sensitive electroconductive members respectively pressed by the plurality of projections to be elastically deformed; a substrate having a plurality of electrode patterns respectively contacting the plurality of pressure-sensitive electroconductive members; and a spacer member disposed between the elastic support member and the substrate and having a plurality of openings arranged so as to avoid the plurality of respective projections.

### Advantageous Effects of the Invention

According to the operation input device of one embodiment of the present invention, when a player operates the distal-end side wall surface of the operating piece in the short side direction of the elongated hole, the operated operating piece is inclined in the short side direction of the elongated hole, and the proximal-end side wall surface of the inclined operating piece deforms the elastic support member, thereby pressing and elastically deforming the pressure-sensitive electroconductive member through the projection provided on the back surface of the elastic support member. Further, when a player operates the distal-end side wall surface of the operating piece in the insertion direction of the operating piece, the operated operating piece is pushed in the insertion direction of the operating piece, and the proximal-end side wall surface of the pushed operating piece deforms the elastic support member, thereby pressing and elastically deforming the pressure-sensitive electroconductive member through the projection provided on the back surface of the elastic support member. Then, a playing operation with respect to the operating piece is detected based on a change in an electric resistance value when the pressure-sensitive electroconductive member is deformed. Thus, operability of the playing operation can be improved with a simple structure.

Problems, configurations and effects other than those described above will be clarified by the description of embodiments below.

### BRIEF DESCRIPTION OF THE DRAWINGS

FIG. 1 is a perspective view illustrating an example of an electronic musical instrument 1 according to an embodiment of the present invention.

FIG. 2 is a front view illustrating an example of the electronic musical instrument 1 according to the embodiment of the present invention.

FIG. 3 is an enlarged front view of a chord designating button group 3, a chord changing button group 4, and a display part 9 which are included in the electronic musical instrument 1 according to the embodiment of the present invention.

FIG. 4 is a block diagram illustrating an example of the electronic musical instrument 1 according to the embodiment of the present invention.

FIG. 5 is a functional explanatory view illustrating an example of the electronic musical instrument 1 according to the embodiment of the present invention.

FIG. 6 is an exploded perspective view as viewed from above, illustrating an example of an operation input device 5 according to the embodiment of the present invention.

FIG. 7 is an exploded perspective view as viewed from below illustrating an example of the operation input device 5 according to the embodiment of the present invention.

FIG. 8 is a transverse cross-sectional view illustrating an example of the operation input device 5 according to the embodiment of the present invention.

FIG. 9 is a longitudinal cross-sectional view illustrating an example of the operation input device 5 according to the embodiment of the present invention.

FIG. 10 is an explanatory view illustrating a first detection method when an operation detection part 56 detects a “hard” playing operation in response to a hard strumming of an operating piece 51.

FIG. 11 is an explanatory view illustrating the first detection method when the operation detection part 56 detects a “soft” playing operation in response to a soft strumming of the operating piece 51.

FIG. 12 is an explanatory view illustrating the first detection method when the operation detection part 56 detects the absence of a playing operation in response to the absence of strumming of the operating piece 51.

FIG. 13 is an explanatory view illustrating a second detection method when the operation detection part 56 detects that a playing operation is present in response to a hard hitting against the operating piece 51.

FIG. 14 is an explanatory view illustrating the second detection method when the operation detection part 56 detects that a “soft” playing operation is present in response to a soft hitting against the operating piece 51.

FIG. 15 is an explanatory view illustrating the second detection method when the operation detection part 56 detects that a playing operation is absent in response to the absence of hitting against the operating piece 51.

### BEST MODE FOR CARRYING OUT THE INVENTION

Hereinafter, embodiments for practicing the present invention will be described with reference to the drawings. In the following description, the scope necessary for the description for achieving the object of the present invention is schematically illustrated, and the scope necessary for the description of the relevant part of the present invention will be mainly described, and the parts omitted herein are identified as known art.

### Configuration of Each Part of Electronic Musical Instrument 1

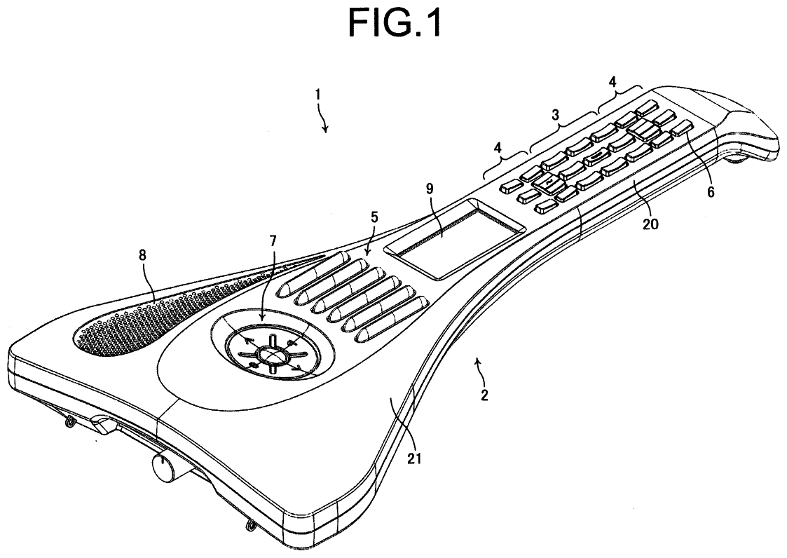

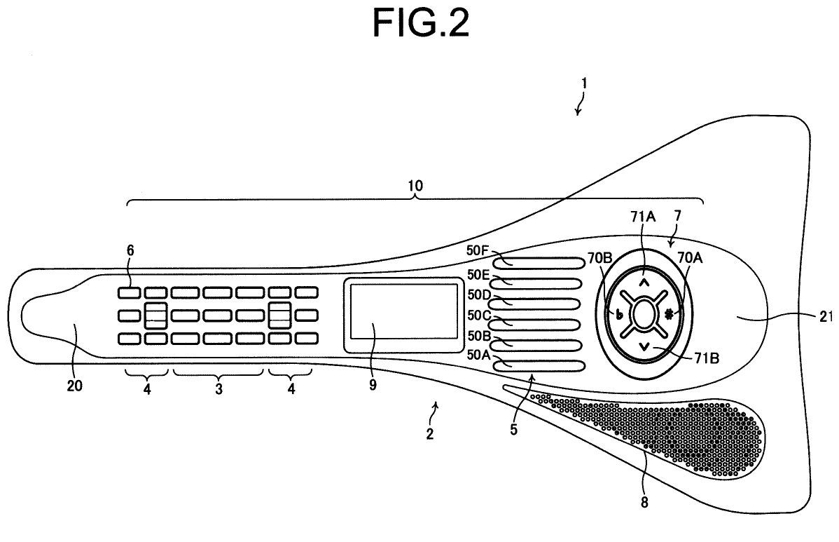

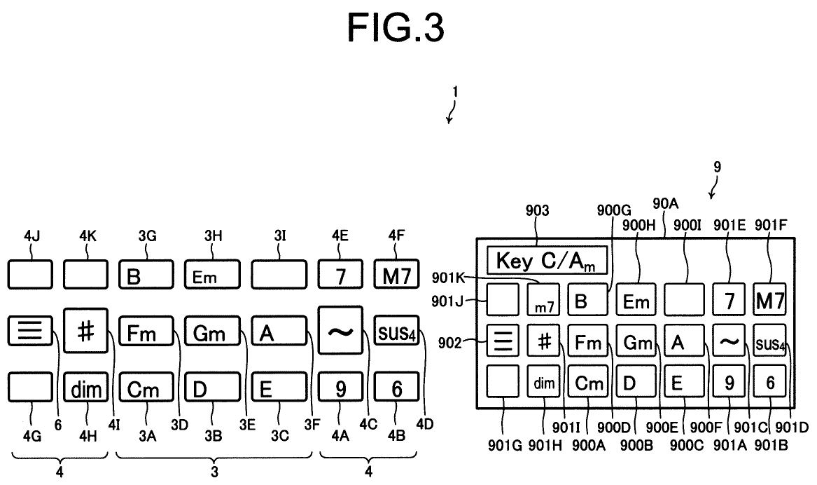

FIG. 1 is a perspective view illustrating an example of an electronic musical instrument 1. FIG. 2 is a front view illustrating an example of the electronic musical instrument 1. FIG. 3 is an enlarged front view of a chord designating button group 3, a chord changing button group 4, and a display part 9 which are included in the electronic musical instrument 1.

The electronic musical instrument 1 is an instrument with which a player can play various music while performing a playing operation with one or both hands. The electronic musical instrument 1 has a main body 2 constituting the outer shape thereof. The main body 2 has an operating part 10 including a chord designating button group 3, a chord changing button group 4, an operation input device 5, a menu button 6, and an option button group 7. The electronic musical instrument 1 further has a sounding part 8, a display part 9, a control part 11, a storage part 12, a battery 13, and an external I/F (interface) part 14. The control part 11, storage part 12, battery 13, and external I/F part 14 are incorporated inside the main body 2.

The main body 2 simulates the shape of a stringed instrument such as a guitar or a bass guitar and is constituted of a neck part 20 corresponding to the neck of the stringed instrument and a body part 21 corresponding to the body of the stringed instrument. The main body 2 is made of wood, resin, metal, or the like and has an entire length of about 400 mm to 500 mm and a thickness of about 10 mm. The size and shape of the main body 2 may be modified as needed. In the present embodiment, the main body 2 is composed of two members (a front side cover and a back side cover) which are formed into a thin plate shape through resin molding.

The chord designating button group 3 includes a plurality of chord designating buttons 3A to 3I, which are arranged on the neck part 20. The chord designating buttons 3A to 3I each have a rectangular shape and are arranged in a two-dimensional or staggered array.

The chord designating buttons 3A to 3I are each assigned with a chord. Specifically, the plurality of chord designating buttons 3A to 3I are each assigned with a first root and a first chord type which constitute each chord. The assignment state of the chords assigned to the chord designating buttons 3A to 3I is not fixed, but can be changed according to a plurality of change methods (details thereof will be described later). The plurality of chord designating buttons 3A to 3I are preferably assigned with chords including at least major triads and sub-triads from I to VI.

The chord changing button group 4 includes a plurality of chord changing buttons 4A to 4K, which are arranged side by side with the plurality of chord designating buttons 3A to 3I on the neck part 20. The plurality of chord changing buttons 4A to 4K each have, for example, a rectangular shape and are arranged adjacent to the chord designating button group 3 in a two-dimensional or staggered array.

The plurality of chord changing buttons 4A to 4K are assigned respectively with a plurality of change methods for changing the chord assignment state for the plurality of chord designating buttons 3A to 3I. The change method is a method of changing at least one of the first root and the first chord type constituting each chord assigned to the plurality of chord designating buttons 3A to 3I according to a predetermined rule. In the present embodiment, the change method is classified into the following three.

In the “first change method”, a second chord type is added to the first chord type, or the first chord type is replaced with the second chord type to change the assignment state. For example, assuming that the chord name indicating a chord to be changed is “Am” and that “M7” or “aug” is specified as the second chord type, the characteristics of the constituent note designated as the second chord type (“M7”) is added to the first chord type “m”, or the first chord type “m” is replaced with the characteristics of the constituent note designated as the second chord type (“aug”) to thereby change the chord to be changed to a new chord (addition: “Am”→“AmM7”, or replacement: “Am”→“Aaug”). In the present embodiment, as the first change method, seven chord changing buttons 4A, 4B, 4D to 4F, 4H, and 4K are assigned respectively with second chord types of “9”, “6” “sus4”, “7”, “M7”, “dim”, and “m7 (−5)”.

In the “second change method”, when the first chord type corresponds to a third chord type, the first chord type is replaced with a fourth chord type different from the third chord type, and when the first chord type corresponds to the fourth chord type, the first chord type is replaced with the third chord type, whereby the assignment state is changed. The chord designating buttons 3A to 3I are each assigned with the third chord type and fourth chord type to change the assignment state according to the second change method. For example, assuming that the chord names indicating the chords to be changed are “C” and “Am” and that “M” and “m” are specified as the third and fourth chord types, respectively, the third chord type and the fourth chord type are replaced with each other (major and minor chords are replaced with each other) to change the chords to be changed to new chords (“C”→“Cm” and “Am”→“A”). In the present embodiment, as the second change method, the chord changing button 4C is assigned with a third chord type of “M” and a fourth chord type of “m”.

In the “third change method”, the assignment state is changed by adding a change symbol (♯, ♭, etc.) to the first root. The chord designating buttons 3A to 3I are assigned respectively with the change symbols to change the assignment state according to the third change method. For example, assuming that the chord name indicating the chord to be changed is “C” and that “♯” or “♭” is specified as the change symbol, the change symbol is added to the first root in the third method to change the chord to be changed to a new chord (“C”→“D♭” or “C”→“C♭”). In the present embodiment, as the third change method, a change symbol of “♯” is assigned to the chord changing button 4I.

The operation input device 5 functions as a playing operation input device for inputting a playing operation and has a plurality of operating pieces 51A to 51F simulating strings of a guitar or a bass guitar. The plurality of operating pieces 51A to 51F each have an outer appearance that is elongate and rounded as a whole and are arranged near the center of the body part 21. The operation input device 5 is configured to detect a playing operation with respect to the operating pieces 51A to 51F. Specifically, the operation input device 5 can detect such a playing operation as to strum the strings of a guitar or a bass guitar with fingers (strumming operation) and a playing operation such as hitting with a finger (percussive operation).

The menu button 6 is arranged side by side with the chord designating buttons 3A to 3I on the neck part 20.

The option button group 7 is disposed in the body part 21 and includes a key up button 70A and a key down button 70B for raising and lowering a key and memory buttons 71A and 71B for reading user setting data stored in the storage part 12.

The sounding part 8 is disposed near one side of the body part 21. The sounding part 8 is constituted by, for example, a sound output device including an amplifier circuit, a speaker, and the like. The sounding part 8 amplifies a signal based on sounding information (details thereof will be described later) generated by the control part 11 and outputs a sound to the outside through the speaker, thereby emitting playing sound according to operation with respect to the chord designating button group 3 and chord changing button group 4. The sounding part 8 may be an external device such as an external speaker, headphones, or earphones.

The display part 9 is disposed side by side with the chord designating button group 3 and chord changing button group 4 at a position between the neck part 20 and the body part 21. The display part 9 is a display device such as a liquid crystal display, an organic EL display, or a touch panel. The display part 9 displays various screens (a performance screen for a user to refer to when playing and a user setting screen for a user to perform various settings) based on display information generated by the control part 11).

As illustrated in FIG. 3, the performance screen 90A includes a plurality of chord images 900A to 900I corresponding to the chords assigned respectively to the chord designating buttons 3A to 3I, a plurality of change method images 901A to 901K corresponding to the change methods assigned respectively to the chord changing buttons 4A to 4K, a menu image 902 corresponding to the menu button 6, and a key image 903 indicating a key set by the key up button 70A and key down button 70B. In FIG. 3, for the sake of explanation, chord names are labeled to the chord designating buttons 3A to 3I.

Each of the chord images 900A to 900I is an image including a chord name indicating a chord. The change method images 901A, 901B, 901D to 901I, and 901K corresponding to the first change method are images including the second chord type. The change method image 901C corresponding to the second change method is an image including the third chord type and fourth chord type. The change method image 901J corresponding to the third change method is an image including the change symbol. The arrangement order of the images (chord images 900A to 900I, change method images 901A to 901K, and menu image 902) on the performance screen 90A coincides with the arrangement order of the buttons (chord designating buttons 3A to 3I, chord changing buttons 4A to 4K, and menu button 6).

As the chord designating button group 3, chord changing button group 4, menu button 6, and option button group 7, any type of sensor may be used as long as it is a sensor capable of detecting the operating state of a player and may be formed as, for example, a pressure sensitive sensor, a contact sensor, a touch panel, or the like. The size, shape, and arrangement state of the chord designating button group 3, chord changing button group 4, menu button 6, and option button group 7 may be modified as needed. The details of the operation input device 5 will be described later.

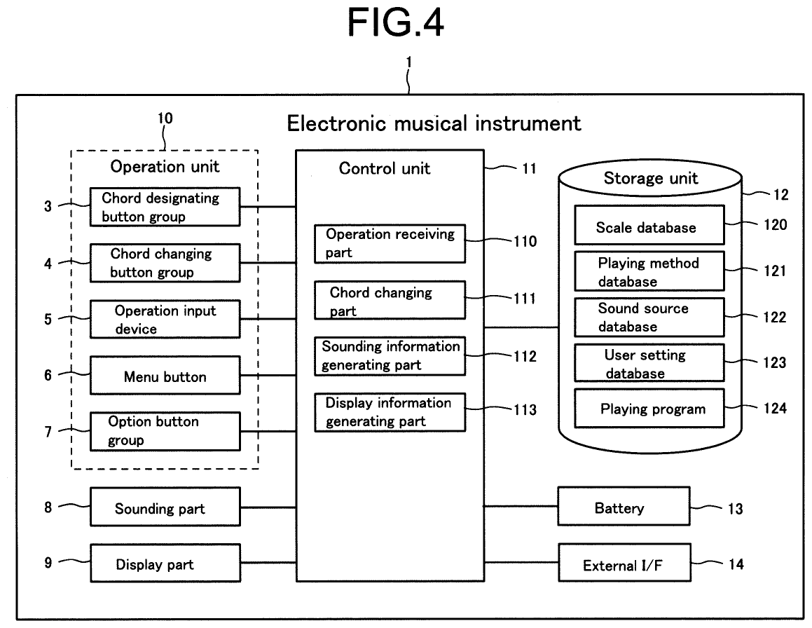

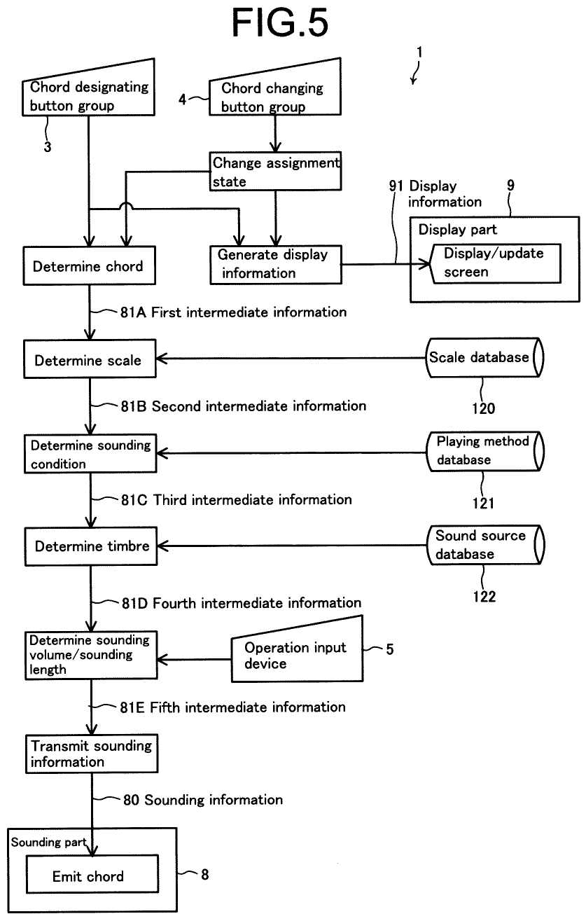

FIG. 4 is a block diagram illustrating an example of the electronic musical instrument 1. FIG. 5 is a functional explanatory view illustrating an example of the electronic musical instrument 1.

The control part 11 is constituted by, for example, an arithmetic processing device such as a processor (CPU, etc.), a sound chip, or a video chip. The control part 11 is electrically connected to the above-described parts of the electronic musical instrument 1.

The storage part 12 is constituted by, for example, a storage device such as an HDD or a memory. The storage part 12 stores a scale database 120, a playing method database 121, a sound source database 122, a user setting database 123, and a playing program 124 as various data necessary for playing the electronic musical instrument 1. These data may be updated over a network such as Internet connected with the electronic musical instrument 1.

The scale database 120 is a database for designating the scale corresponding to the constituent notes of a chord with, for example, note numbers. For example, the scale database 120 stores a note number corresponding to each constituent note for each chord.

The playing method database 121 is a database for generating sounding information according to a playing method used in emitting a chord sound. The playing method database 121 stores sounding condition (reference sounding volume, sounding length, etc.) for each playing method such as chord playing, root playing, stroke, and arpeggio.

The sound source database 122 is a database for generating sounding information according to a timbre used in emitting a chord sound. The sound source database 122 stores sound source data for each timbre of a guitar, piano, drum, or the like, for example. As the sound source data, various formats such as an FM sound source, a MIDI sound source, and a PCM sound source are used.

The user setting database 123 is a database for storing various parameters that can be set by a player. The user setting database 123 is composed of a plurality of user setting data and stores parameters such as an assignment state, a key, a playing method, and a timbre for each user setting data. The user setting database 123 is read by the control part 11 in response to operation with respect to the memory buttons 71A and 71B and configured to be changeable on the setting screen.

The battery 13 is constituted by, for example, a primary battery or a secondary battery. The battery 13 supplies electric power to each part of the electronic musical instrument 1 when a power switch (not illustrated) of the electronic musical instrument 1 is turned on. The electronic musical instrument 1 may be externally supplied with electric power through, for example, an AC adapter or a USB cable.

The external I/F part 14 is constituted by, for example, a communication device and is connected to an external device or a network by wire or wirelessly to transmit and receive information. The external I/F part 14 includes an input/output terminal connected to an external device by wire and a wireless communication part that supports communication standards such as Bluetooth® and wireless LAN.

The control part 11 functions as an operation receiving part 110, a chord changing part 111, a sounding information generating part 112, and a display information generating part 113 by executing the playing program 124 stored in the storage part 12. The control part 11 receives operation with respect to the operating part 10 and, in response to the operation, controls the sounding part 8, display part 9, and external I/F part 14 while referring to various databases 120 to 123 stored in the storage part 12.

The operation receiving part 110 receives operation with respect to the operating part 10.

When the operation receiving part 110 receives operation with respect to one of the chord changing buttons 4A to 4K, the chord changing part 111 changes the assignment state according to the change method assigned to the operated chord changing button. The chord changing part 111 maintains the thus changed assignment state while the chord changing button is operated (depressed) and returns this chord assignment state to the original assignment state when the operation for the chord changing button is released.

When the operation receiving part 110 receives an operation with respect to one of the chord designating buttons 3A to 3I and receives an operation with respect to the operation input device 5 (at least one of the plurality of operating pieces 51A to 51F), the sounding information generating part 112 generates sounding information 80 based on the chord assigned to the operated one of the chord designating buttons 3A to 3I.

Specific processing when the sounding information generating part 112 generates the sounding information 80 is as illustrated in FIG. 5. That is, when the operation with respect to one of the plurality of chord designating buttons 3A to 3I is received, the sounding information generating part 112 specifies a chord corresponding to the operation, by referring to, for example, a chord name (first intermediate information 81A) to determine the chord to be emitted as a sound by the sounding part 8. At this time, when one of the plurality of chord changing buttons 4A to 4K has been operated, the sounding information generating part 112 determines the chord to be emitted as a sound by the sounding part 8 based on a state where the assignment state is changed according to the change method assigned to the operated one of the chord changing buttons 4A to 4K.

The sounding information generating part 112 refers to the scale database 120 based on the chord name indicated by the first intermediate information 81A to determine a scale (second intermediate information 81B) corresponding to the constituent notes of the chord. The sounding information generating part 112 refers to the playing method database 121 to determine a sounding condition (third intermediate information 81C=scale+sounding condition) for emitting a chord sound. The sounding information generating part 112 refers to the sound source database 122 to determine a timbre (fourth intermediate information 81D=scale+sounding condition+timbre) for emitting a chord sound. When an operation with respect to the operation input device 5 (at least one of the plurality of operating pieces 51A to 51F) is received, the sounding information generating part 112 determines sounding volume and sounding length based on playing operation detection data (dynamics, length, etc.) transmitted from the operation input device 5. The sounding information generating part 112 generates, based on fifth intermediate information 81E (scale+sounding condition+timbre+playing operation detection data), the sounding information 80 for making the sounding part 8 emit a sound specified by the scale and the timbre according to the sounding condition and playing operation detection data and transmits the generated sounding information 80 to the sounding part 8.

The display information generating part 113 generates, in response to the operation received by the operation receiving part 110, display information 91 for making the display part 9 display the performance screen 90A (see FIG. 3) and setting screen.

A player who plays the thus configured electronic musical instrument 1 grasps the neck part 20 of the main body 2 with the left hand (or right hand) and supports the body part 21 with the right hand (or left hand). In this attitude, the player depresses the chord designating button group 3 and chord changing button group 4 with the fingers of the right hand (or left hand) and strums the plurality of operating pieces 51A to 51F with the fingers of the right hand (or left hand). Alternatively, in a state where the main body 2 is placed on a table, for example, the player depresses the chord designating button group 3 and chord changing button group 4 with the fingers of the left hand (or right hand) and strums, hits, or holds the plurality of operating pieces 51A to 51F with the right hand (or left hand).

### Detailed Configuration of Operation Input Device 5

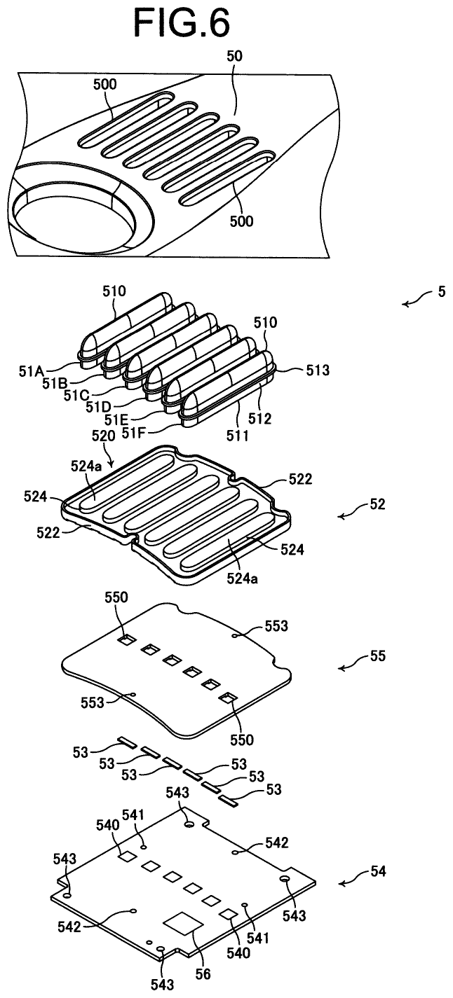

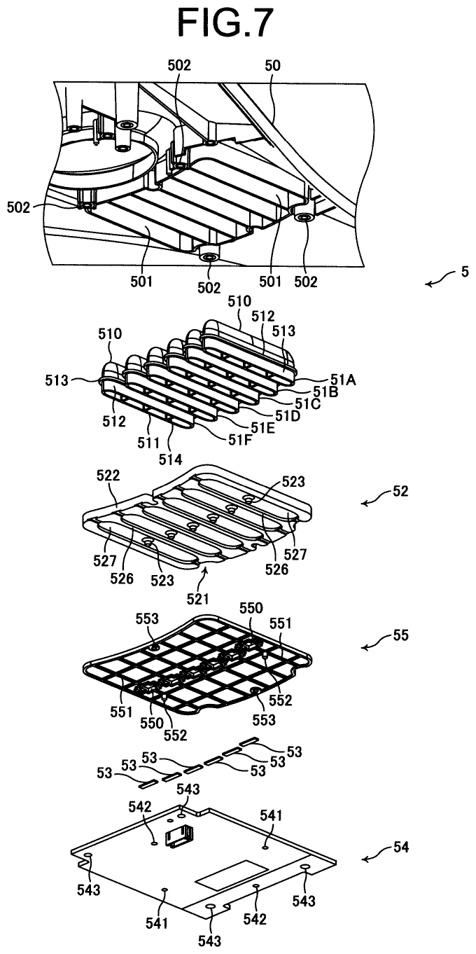

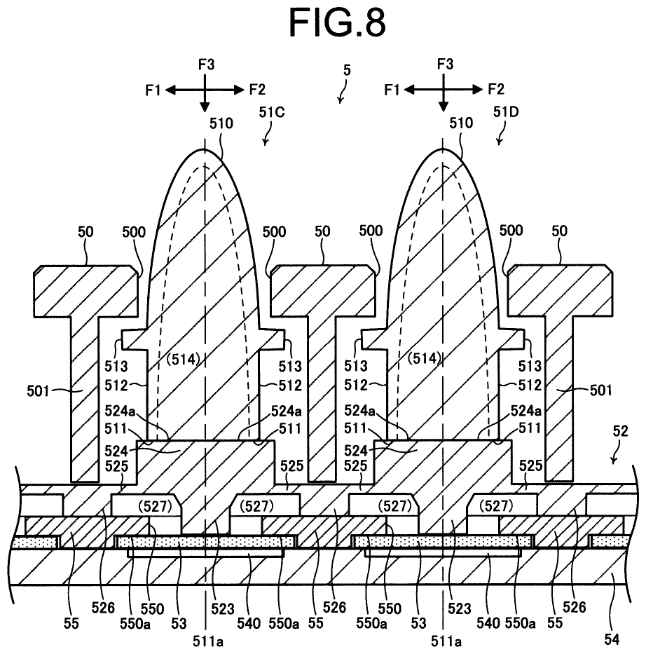

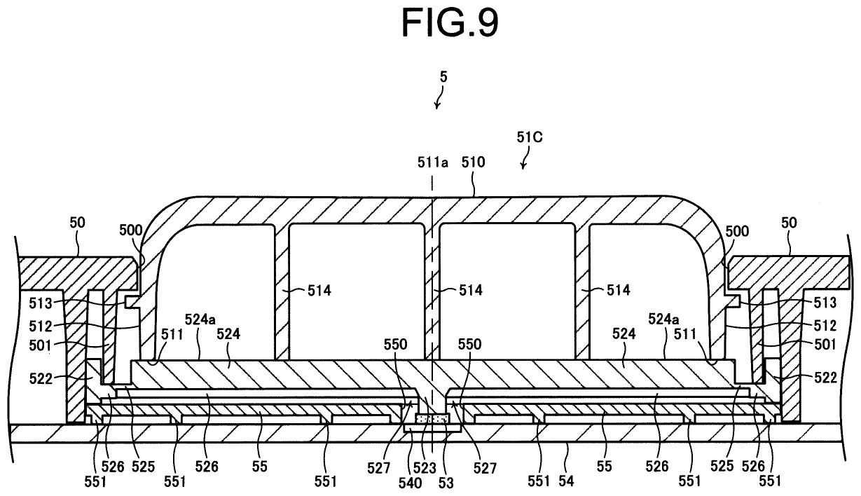

FIGS. 6 and 7 are an exploded perspective view as seen from above and an exploded perspective view as seen from below each illustrating an example of the operation input device 5. FIGS. 8 and 9 are a transverse cross-sectional view and a longitudinal cross-sectional view each illustrating an example of the operation input device 5. Although FIG. 8 illustrates only two operating pieces 51C and 51D, and FIG. 9 illustrates only one operating piece 51C, other operating pieces have the same configuration.

The operation input device 5 has a casing 50, a plurality of operating pieces 51A to 51F, an elastic support member 52, a plurality of pressure-sensitive electroconductive members 53, a substrate 54, a spacer member 55, and an operation detection part 56.

The casing 50 has a plurality of elongated holes 500 arranged such that long sides thereof have a prescribed interval therebetween. The elongated holes 500 are each formed into a round-cornered rectangular shape as viewed from the front so as to be matched with the shape of each of the operating pieces 51A to 51F. The shape of the elongated hole is not limited to the round-cornered rectangle, but may be a simple rectangle, an oval, or the like.

In the present embodiment, the casing 50 is constituted by a part of the main body 2 of the electronic musical instrument 1 and has a housing wall 501 vertically extending so as to house therein each of the plurality of operating pieces 51A to 51F and four screw holes 502.

The plurality of operating pieces 51A to 51F each have a distal-end side wall surface 510 having a rounded and curved shape, a proximal-end side wall surface 511 formed on the opposite side from the distal-end side wall surface 510, a peripheral side surface 512 positioned between the distal-end side wall surface 510 and the proximal-end side wall surface 511, and a receiving part 513 formed into a stripe shape so as to surround the peripheral side surface 512. In the present embodiment, the operating pieces 51A to 51F are each formed into a hollowed cap-like shape through resin molding and each have three reinforcing ribs 514 provided so as to partition the hollow at equal intervals in the long side direction.

The plurality of operating pieces 51A to 51F are inserted respectively into the plurality of elongated holes 500 and held by the casing 50 in a state where the distal-end side wall surfaces 510 protrude from the casing 50 so as to be operable in the short-side direction (arrows F1 and F2 in FIG. 8) of the elongated hole 500 and the insertion direction (arrow F3 in FIG. 8). The operating pieces 51A to 51F are each designed such that a predetermined gap (backlash) is formed between the peripheral side surface 512 and the elongated hole 500 as they are inserted into the respective elongated holes 500 and that the receiving part 513 functions as a stopper for preventing the operating pieces 51 to 51F from coming off from the elongated hole 500.

The elastic support member 52 is made of a plate-like elastic material (e.g., a silicon rubber) having a predetermined thickness. The elastic support member 52 has a front surface 520 that supports the proximal-end side wall surface 511 of each of the plurality of operating pieces 51A to 51F, a back surface 521 positioned on the opposite side from the front surface 520 in the thickness direction and having a plurality of projections 523 provided in positions corresponding to the proximal-end side wall surfaces 511 of the plurality of operating pieces 51A to 51F, and a side edge part 522 formed along the side surface thereof.

The elastic support member 52 has a plurality of support parts 524 each formed into a pedestal shape and each having a support surface 524a on which the proximal-end side wall surface 511 of each of the plurality of operating pieces 51A to 51F is supported and a thin part 525 formed around each of the plurality of support parts 524 and having a thickness smaller than that of a portion at which the support part 524 is formed. The elastic support member 52 has, on the back surface 521, a plurality of projecting parts 526 formed so as not to overlap the portions at which the support parts 524 are formed and a plurality of concave parts 527 formed so as to include the periphery around the portions at which the plurality of support parts 524 are formed. Accordingly, in the elastic support member 52, a portion at which one of the support part 524 and projecting part 526 is formed has a relatively large thickness, and a portion (i.e., thin part 525) at which neither the support part 524 nor projecting part 526 is formed has a relatively small thickness.

The projections 523 are each formed into, e.g., a tapered conical shape on the opposite side from the proximal-end side wall surface 511 supported by the surface 520 (support surface 524a of the support part 524) as a position corresponding to the proximal-end side wall surface 511 of each of the plurality of operating pieces 51A to 51F, i.e., on the back surface 521 at a position opposite to each of the support surfaces 524a across the elastic support member 52. In the present embodiment, the projections 523 are each provided at a position (center portion of the concave part 527) corresponding to a center part 511a of the proximal-end side wall surface 511. The size and shape of the projection 523 may be modified as needed. For example, the projection 523 may be formed into a columnar shape, a prism shape, or a truncated pyramid shape.

The plurality of pressure-sensitive electroconductive members 53 are each made of a pressure-sensitive electroconductive material whose electric resistance value changes when being elastically deformed by a predetermined pressing force. The pressure-sensitive electroconductive material is manufactured by adding conductive particles to insulating rubber, for example. The electric resistance value of the pressure-sensitive electroconductive material is high in the absence of a pressing force and decreases as the pressing force becomes larger.

The plurality of pressure-sensitive electroconductive members 53 are disposed at positions contacting the plurality of respective projections 523 and are elastically deformed when being pressed by the plurality of respective projections 523. The plurality of pressure-sensitive electroconductive members 53 are each formed into, e.g., a strip shape and are each disposed such that the longitudinal direction thereof extends along the short-side direction (F1↔F2) of the elongated hole 500 so as to stride over a plurality of openings 550 that the spacer member 55 has.

The substrate 54 has a plurality of electrode patterns 540 contacting the plurality of respective pressure-sensitive electroconductive members 53. The electrode patterns 540 are each constituted by a pair of electrodes formed into, e.g., a comb shape so as not to contact each other. The substrate 54 further has two positioning holes 541 for positioning the spacer member 55, two first through holes 542 through which two screws (not illustrated) for fixing the substrate 54 and spacer member 55 (screw holes 553) penetrate, and four second through holes 543 through which four screws (not illustrated) for fixing the substrate 54 and casing 50 (screw holes 502) penetrate.

The spacer member 55 is formed of a plate-like resin material (polypropylene resin, urethane resin, etc.) having a predetermined thickness and has a plurality of rectangular openings 550 and a lattice-like rib 551 formed on the substrate 54 side. The spacer member 55 is disposed between the elastic support member 52 and the substrate 54. The plurality of openings 550 are arranged so as to avoid the plurality of respective projections 523 and each have, inside thereof, a step surface 550a for disposing both end portions of the pressure-sensitive electroconductive member 53 in its longitudinal direction. The spacer member 55 further has two positioning pins 552 inserted into the respective positioning holes 541 of the substrate 54 and two screw holes 553.

A method of assembling the operation input device 5 is as follows. The plurality of pressure-sensitive electroconductive members 53 are positioned to the plurality of openings 550 (step surfaces 550a) of the spacer member 55, and the positioning pins 552 are positioned so as to be inserted into the positioning holes 541 of the substrate 54. In this state, screws penetrating the first through holes 542 of the substrate 54 are fastened to the screw holes 553 of the spacer member 55. As a result, the substrate 54 and spacer member 55 are fixed to each other with the plurality of pressure-sensitive electroconductive members 53 held between the substrate 54 and the spacer member 55.

Then, the plurality of operating pieces 51A to 51F are inserted into the plurality of respective elongated holes 500 of the casing 50 from the distal-end side wall surface 510, and the plurality of support parts 524 (support surfaces 524a) of the elastic support member 52 are positioned to the proximal-end side wall surfaces 511 of the respective operating pieces 51A to 51F. In this state, the elastic support member 52 is disposed. Then, in a state where the plurality of projections 523 of the elastic support member 52 are positioned so as to be inserted into the plurality of respective openings 550 of the spacer member 55 that has already been fixed to the substrate 54, screws penetrating the second through holes 543 of the substrate 54 are fastened to the screw holes 502 of the casing 50. As a result, assembly of the operation input device 5 is completed.

The size, shape, and arrangement state, and material of each of the casing 50, operating pieces 51A to 51F, elastic support member 52, pressure-sensitive electroconductive members 53, substrate 54, and spacer member 55 are not limited to those described in the above examples and may be modified as needed. In this case, the young's modulus (longitudinal elasticity) of an elastic material of the elastic support member 52 may be modified as needed. Further, the casing 50 may be configured as a separate member from the main body 2 of the electronic musical instrument 1. In this case, the operation input device 5 whose assembly has been completed may be mounted to the main body 2.

The operation detection part 56 is constituted by, e.g., a power supply circuit, a voltage sensor, a current sensor, and a control circuit (e.g., a microcontroller including a processor, a memory, and the like). The operation detection part 56 may be provided in a substrate different from the substrate 54. Further, the operation detection part 56 may be provided in a separate device from the operation input device 5, may be incorporated in the control part 11 as one function of the control part 11, or may be realized by the playing program 124 as a part of the playing program 124.

The operation detection part 56 is connected to each of the plurality of electrode patterns 540 (specifically, a pair of electrodes having a comb shape) and detects a playing operation with respect to each of the plurality of operating pieces 51A to 51F based on a change in an electric resistance value occurring when each of the plurality of pressure-sensitive electroconductive members 53 is elastically deformed. Then, the operation detection part 56 transmits playing operation detection data indicating the content of a detected playing operation to the control part 11. The playing detection data includes, for example, identifiers indicating any of the operating pieces 51A to 51F with respect to which a playing operation is performed, dynamics in the playing operation, length of the playing operation, type (strumming operation, percussive operation, etc.) of the playing operation, and the like.

The operation detection part 56 converts, based on a conversion table or a conversion expression for converting the electric resistance value of the pressure-sensitive electroconductive member 53 into a pressure value, the electric resistance value detected when any of the operating pieces 51A to 51F are operated into an operation pressure value P indicating the value of pressure applied to any of the operating pieces 51A to 51F. Then, the operation detection part 56 monitors a change state (change amount, change speed, etc.) of the operation pressure value P to detect a playing operation with respect to any of the operating pieces 51A to 51F. The operation detection part 56 may detect a playing operation by monitoring the electric resistance value of the pressure-sensitive electroconductive member 53 without converting the electric resistance value of the pressure-sensitive electroconductive member 53 into the operation pressure value P.

A method for the operation detection part 56 to detect a playing operation is classified into the following two types depending on the difference in a playing method.

### First Detection Method by Operation Detection Part 56

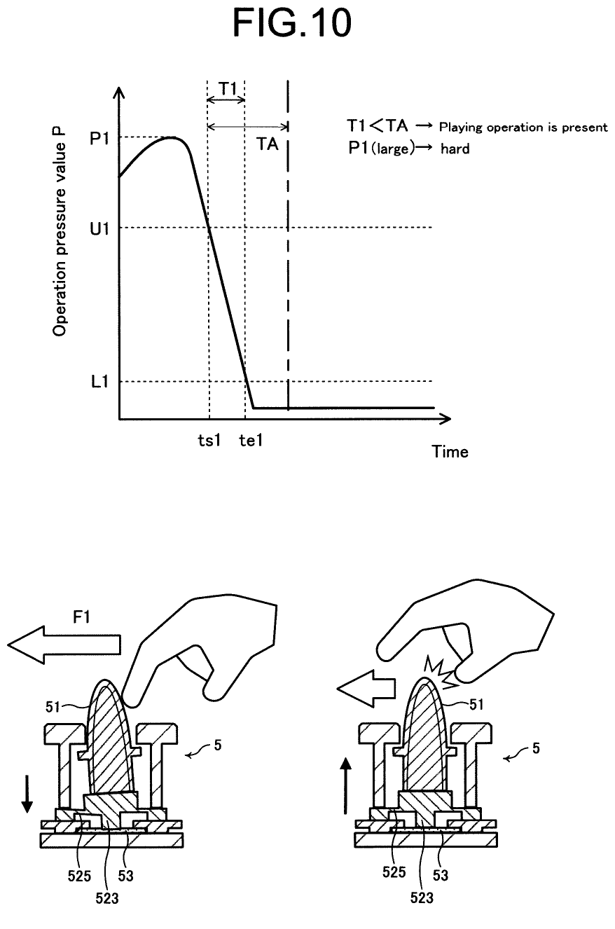

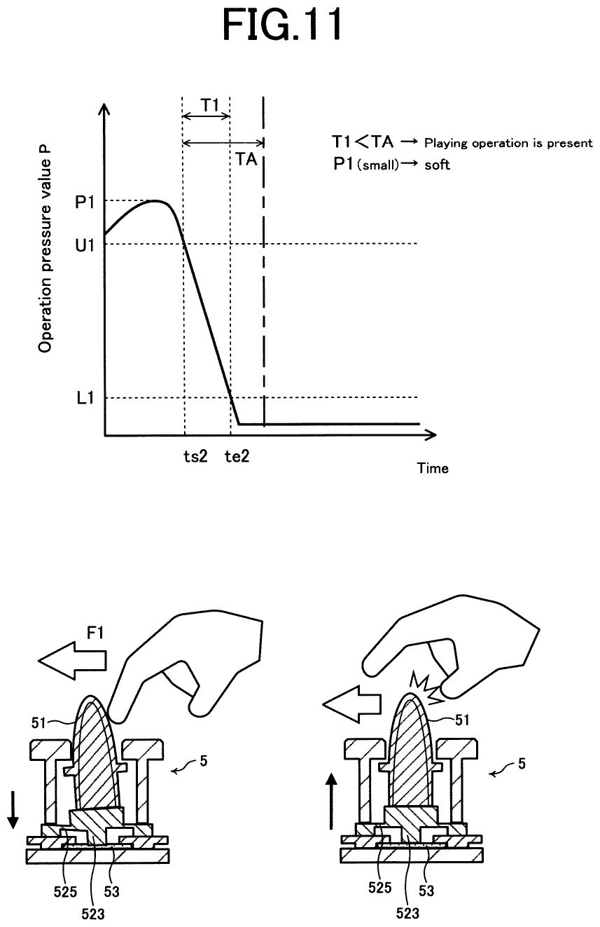

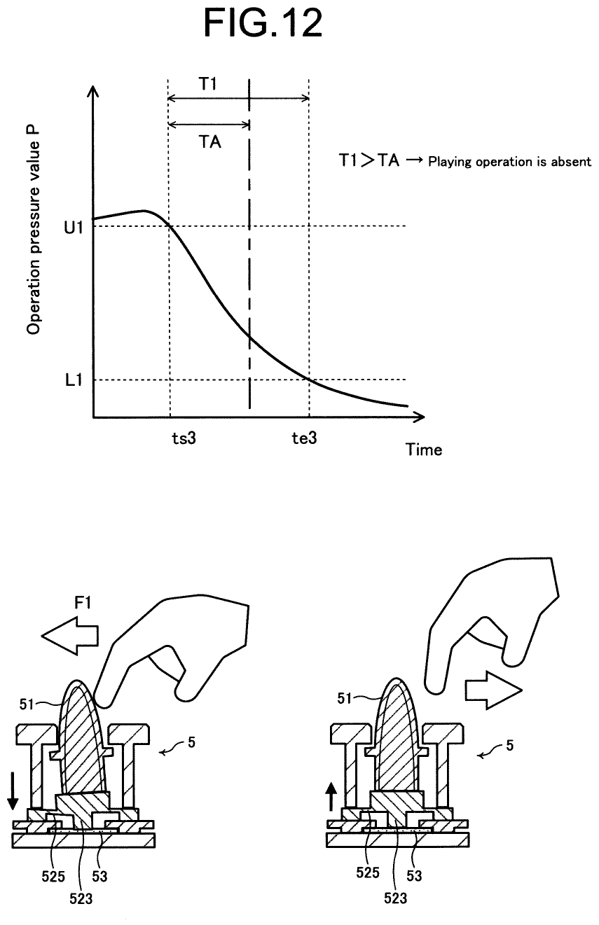

FIG. 10 is an explanatory view illustrating a first detection method when the operation detection part 56 detects that a “hard” playing operation is present in response to a hard strumming of the operating piece 51. FIG. 11 is an explanatory view illustrating the first detection method when the operation detection part 56 detects that a “soft” playing operation is present in response to a soft strumming of the operating piece 51. FIG. 12 is an explanatory view illustrating the first detection method when the operation detection part 56 detects that a playing operation is absent in response to the absence of strumming of the operating piece 51. The first detection method is a method of detecting such a strumming operation that a player strums the operating piece 51 with the finger in the short side direction (F1↔F2).

In the first detection method, the operation detection part 56 monitors a change state when an operation pressure value P lowers after rising to detect the presence/absence and dynamics in the strumming operation. Specifically, the operation detection part 56 detects the presence/absence of the playing operation to operate the operating piece 51 in the short side direction (F1↔F2) in accordance with the length of a first elapsed time T1 from when the operation pressure value P falls below a predetermined first upper limit threshold value U1 after exceeding the predetermined first upper limit threshold value U1 until it falls below a predetermined first lower limit threshold value L1. Further, the operation detection part 56 detects dynamics in the playing operation in accordance with a first peak value appearing after the operation pressure value P exceeds the first upper limit threshold value U1.

When a player operates the distal-end side wall surface 510 of the operating piece 51 in the short side direction F1 with his or her finger as illustrated in FIGS. 10 to 12, an operation pressure acts on the operating piece 51 in the short side direction F1. The operation pressure is transmitted from the proximal-end side wall surface 511 of the operating piece 51 to the support part 524 of the elastic support member 52 to elastically deform the elastic support member 52 (in particular, the thin part 525 formed on the short side direction F1 of the support part 524) to thereby displace the operating piece 51 such that it is inclined in the short side direction F1. Then, in association with the displacement, the projection 523 is displaced so as to press the pressure-sensitive electroconductive member 53, causing a predetermined pressing force to act on the pressure-sensitive electroconductive member 53. As a result, the operation detection part 56 detects that the operation pressure value P rises to exceed the first upper limit threshold value U1 as the change amount of the electric resistance value of the pressure-sensitive electroconductive member 53.

In the above situation, when the player strums the operating piece 51 in such a manner as to swing his or her finger to the opposite side of the operating piece 51 as illustrated in FIGS. 10 and 11, a time period during which the elastic support member 52 restores to its original shape as a reaction to the above operation decreases, so that a change speed of the electric resistance value of the pressure-sensitive electroconductive member 53 increases. In this case, the first elapsed time T1 (=te1−ts1 or te2−ts2) measured when the operation pressure value P lowers decreases, and the operation detection part 56 compares the first elapsed time T1 and a first operation detection threshold value TA and detects that the playing operation is present when the first elapsed time T1 is equal to or less than the first operation detection threshold value TA (see FIGS. 10 and 11).

When the operating piece 51 is strummed hard (see FIG. 10), the first peak value P1 appearing after the operation pressure value P exceeds the first upper limit threshold value U1 becomes large, so that the operation detection part 56 detects that a “hard” playing operation is present based on the first peak value P1. Further, when the operating piece 51 is strummed softly (see FIG. 11), the first peak value P1 appearing after the operation pressure value P exceeds the first upper limit threshold value U1 becomes small, so that the operation detection part 56 detects that a “soft” playing operation is present based on the first peak value P1. The operation detection part 56 may detect dynamics in the playing operation as a discrete or continuous value in accordance with the magnitude of the first peak value P1.

On the other hand, when the player strums the operating piece 51 in such a manner as not to swing his or her finger to the opposite side of the operating piece 51 but to return it back as illustrated in FIG. 12, a time period during which the elastic support member 52 restores to its original shape as a reaction to the above operation increases, so that a change speed of the electric resistance value of the pressure-sensitive electroconductive member 53 decreases. Thus, the first elapsed time T1 (=te3−ts3) that the operation detection part 56 measures when the operation pressure value P lowers increases. In this case, the first elapsed time T1 (=te3−ts3) that the operation detection part 56 measures when the operation pressure value P lowers increases, and the operation detection part 56 compares the first elapsed time T1 and the first operation detection threshold value TA and detects that the playing operation is absent when the first elapsed time T1 exceeds the first operation detection threshold value TA.

### Second Detection Method by Operation Detection Part 56

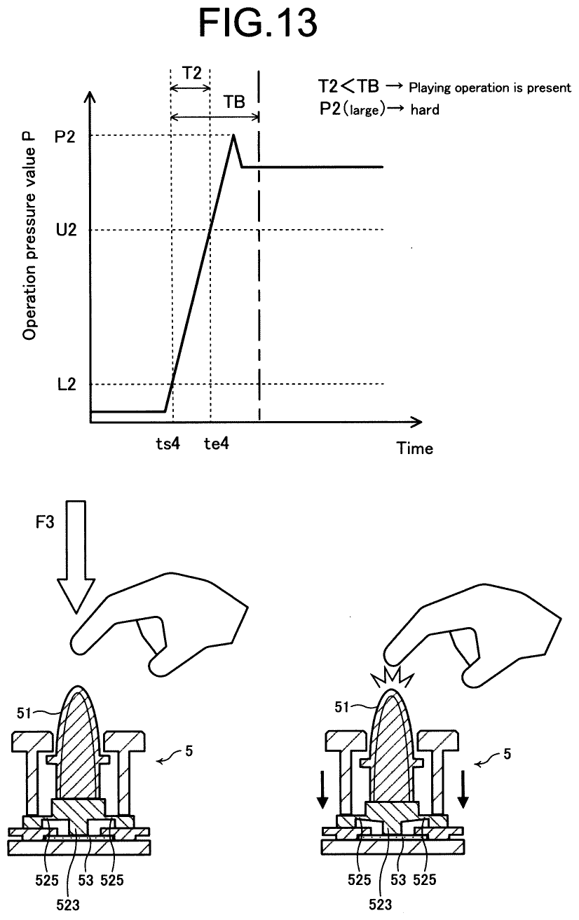

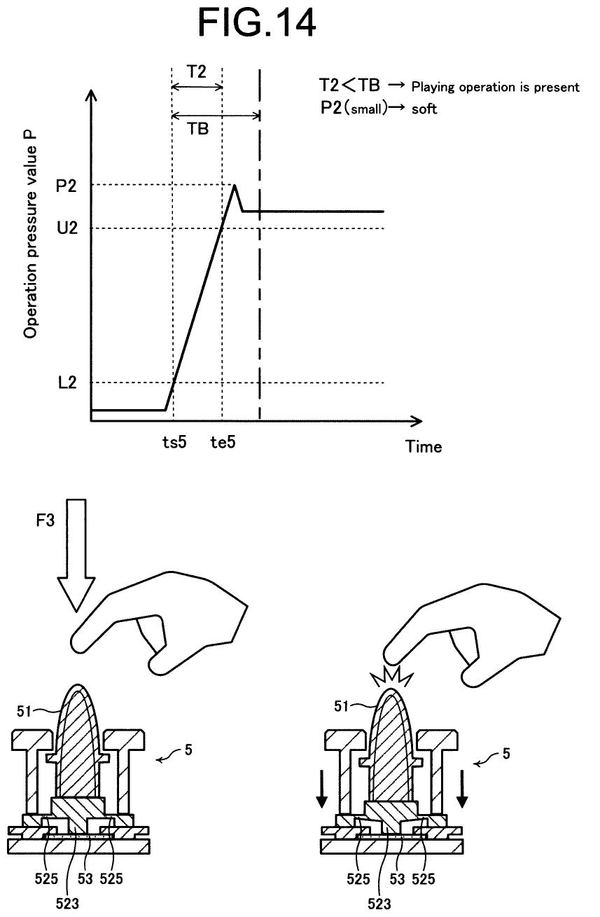

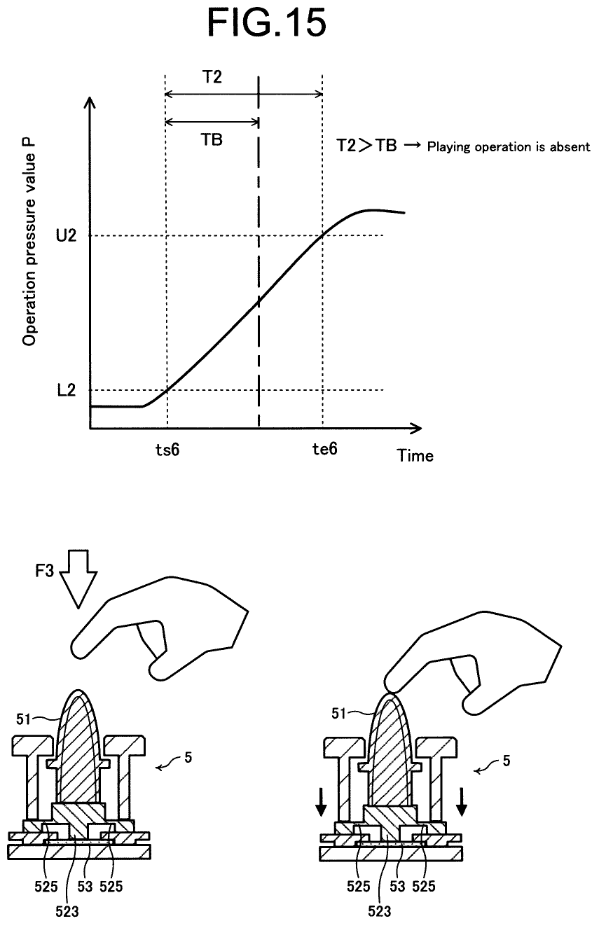

FIG. 13 is an explanatory view illustrating a second detection method when the operation detection part 56 detects that a playing operation is present in response to a hard hitting against the operating piece 51. FIG. 14 is an explanatory view illustrating the second detection method when the operation detection part 56 detects that a “soft” playing operation is present in response to a soft hitting against the operating piece 51. FIG. 15 is an explanatory view illustrating the second detection method when the operation detection part 56 detects that a playing operation is absent in response to the absence of hitting against the operating piece 51. The second detection method is a method of detecting such a percussive operation that a player hits the operating piece 51 with the finger in an insertion (pushing) direction F3.

In the second detection method, the operation detection part 56 monitors a change state when the operation pressure value P rises to detect the presence of and dynamics in the percussive operation. Specifically, the operation detection part 56 detects the presence of the playing operation to operate the operating piece 51 in the insertion direction F3 in accordance with the length of a second elapsed time T2 from when the operation pressure value P exceeds a predetermined second lower limit threshold value L2 until it exceeds a predetermined second upper limit threshold value U2. Further, the operation detection part 56 detects dynamics in the playing operation in accordance with a second peak value appearing after the operation pressure value P exceeds the second upper limit threshold value U2.

When a player operates the distal-end side wall surface 510 at the distal end of the operating piece 51 in the insertion direction F3 with his or her finger as illustrated in FIGS. 13 to 15, an operation pressure acts on the operating piece 51 in the insertion direction F3. The operation pressure is transmitted from the proximal-end side wall surface 511 of the operating piece 51 to the support part 524 of the elastic support member 52 to elastically deform the elastic support member 52 (in particular, the thin part 525 formed around the entire periphery of the support part 524) to thereby displace the operating piece 51 such that it is pushed in the insertion direction F3. Then, in association with the displacement, the projection 523 is displaced so as to press the pressure-sensitive electroconductive member 53, causing a predetermined pressing force to act on the pressure-sensitive electroconductive member 53. As a result, the operation detection part 56 detects that the operation pressure value P rises to exceed the second upper limit threshold value U2 as the change amount of the electric resistance value of the pressure-sensitive electroconductive member 53.

In the above situation, when the player hits the operating piece 51 in the insertion direction F3 with his or her finger as illustrated in FIGS. 13 and 14, a time period during which the elastic support member 52 is elastically deformed so as to be pushed in the insertion direction F3 decreases, so that a change speed of the electric resistance value of the pressure-sensitive electroconductive member 53 increases. Accordingly, the second elapsed time T2 (=te4−ts4 or te5−ts5) measured when the operation pressure value P rises decreases. In this case, the second elapsed time T2 (=te4−ts4 or te5−ts5) measured when the operation pressure value P rises decreases, and the operation detection part 56 compares the second elapsed time T2 and a second operation detection threshold value TB and detects that the playing operation is present when the second elapsed time T2 is equal to or less than the second operation detection threshold value TB (see FIGS. 13 and 14).

When the operating piece 51 is hit hard (see FIG. 13), the second peak value P2 appearing after the operation pressure value P exceeds the second upper limit threshold value U2 becomes large, so that the operation detection part 56 detects that a “hard” playing operation is present based on the second peak value P2. Further, when the operating piece 51 is hit softly (see FIG. 14), the second peak value P2 appearing after the operation pressure value P exceeds the second upper limit threshold value U2 becomes small, so that the operation detection part 56 detects that a “soft” playing operation is present based on the second peak value P2. The operation detection part 56 may detect dynamics in the playing operation as a discrete or continuous value in accordance with the magnitude of the second peak value P2.

On the other hand, when the player places his or her finger on the operating piece 51 without hitting the operating pieces 51 in the insertion direction F3 as illustrated in FIG. 15, a time period during which the elastic support member 52 is elastically deformed so as to be pushed in the insertion direction F3 increases, so that a change speed of the electric resistance value of the pressure-sensitive electroconductive member 53 decreases. Thus, the second elapsed time T2 (=te6−ts6) that the operation detection part 56 measures when the operation pressure value P rises increases. In this case, the second elapsed time T2 (=te6−ts6) that the operation detection part 56 measures when the operation pressure value P rises increases, and the operation detection part 56 compares the second elapsed time T2 and the second operation detection threshold value TB and detects that the playing operation is absent when the second elapsed time T2 exceeds the second operation detection threshold value TB.

The operation detection part 56 may detect the playing operation using either the first detection method or second detection method or using both the first detection method and second detection method. Further, the operation detection part 56 may be configured to switch, with the menu button 6 or on the setting screen, between a strumming operation mode of detecting the playing operation using the first detection method and a percussive operation mode of detecting the playing operation using the second detection method.

As described above, with the operation input device 5 according to the present embodiment, when a player operates the distal-end side wall surface 510 of the operating pieces 51A to 51F in the short side direction (F1↔F2) of the elongated hole 500, the operating pieces 51A to 51F is inclined in the short side direction (F1↔F2). The proximal-end side wall surface 511 of the inclined operating piece 51 elastically deforms the elastic support member 52 to press the pressure-sensitive electroconductive member 53 through the projection 523 provided on the back surface 521 of the elastic support member 52, thereby elastically deforming the pressure-sensitive electroconductive member 53. Further, when a player operates the distal-end side wall surface 510 of the operating pieces 51A to 51F in the insertion direction F3 of the operating pieces 51A to 51F, the operating pieces 51A to 51F are pushed in the insertion direction F3 of the operating pieces 51A to 51F. The proximal-end side wall surface 511 of the inclined operating pieces 51A to 51F elastically deforms the elastic support member 52 to press the pressure-sensitive electroconductive member 53 through the projection 523 provided on the back surface 521 of the elastic support member 52, thereby elastically deforming the pressure-sensitive electroconductive member 53. Then, based on a change in the electric resistance value occurring when the pressure-sensitive electroconductive member 53 is elastically deformed, the playing operation with respect to the operating pieces 51A to 51F is detected. This can improve operability of the playing operation with a simple structure.

Further, the operating pieces 51A to 51F are provided independently of other members. This facilitates replacement of the operating pieces 51A to 51F when they are damaged.

Further, the projection 523 of the elastic support member 52 is provided at a position (center of the concave part 527) corresponding to the center part 511a of the proximal-end side wall surface 511 of the operating pieces 51A to 51F. Thus, even when the operating pieces 51A to 51F are operated in either the short side direction (F1↔F2) or insertion direction F3 and even when the operating pieces 51A to 51F are operated at any position (center portion in the long side direction, both end portions in the long side direction, etc.), an operation pressure with respect to the operating pieces 51A to 51F can be made to act reliably on the pressure-sensitive electroconductive member 53 through the projection 523. This can improve detection performance with respect to the playing operation. Further, it is not necessary to provide a plurality of sets of the pressure-sensitive electroconductive members 53 for one operating piece 51 (51A to 51F), so that an increase in manufacturing cost can be suppressed.

Further, the pressure-sensitive electroconductive member 53 is formed into a strip shape and disposed such that the longitudinal direction of the strip shape extends along the short side direction (F1↔F2) of the elongated hole 500. Thus, even if the distal end of the projection 523 is displaced in the short side direction (F1↔F2) when the operating pieces 51A to 51F are operated in the short side direction (F1↔F2) to displace the projection 523 such that it presses the pressure-sensitive electroconductive member 53, an operation pressure with respect to the operating pieces 51A to 51F can be made to act reliably on the pressure-sensitive electroconductive member 53 through the projection 523. This can improve the performance of playing operation detection.

### Other Embodiments

The present invention is not limited to the above-described embodiment, and various modifications may be made thereto without departing from the scope of the present invention. Accordingly, all such modifications are included in the technical idea of the present invention.

For example, in the above embodiment, the number of the plurality of operating pieces 51A to 51F of the operation input device 5 corresponds to the number (six) of guitar strings; however, the number of the operating pieces 51A to 51F provided in the operation input device 5 may be changed as needed. In this case, the operation input device 5 is configured such that the numbers of the elongated holes 500 of the casing 50, projections 523 of the elastic support member 52, pressure-sensitive electroconductive members 53, electrode patterns 540 of the substrate 54, and openings 550 of the spacer member 55 are changed in accordance with the number of the operating pieces 51A to 51F.

Further, in the above embodiment, the casing 50, elastic support member 52, substrate 54, and spacer member 55 are each provided in common for the plurality of operating pieces 51A to 51F of the operation input device 5; however, the casing 50, elastic support member 52, substrate 54, and spacer member 55 may be provided for each individual operating piece 51. In this case, the operation input device 5 is configured such that the numbers of the elongated holes 500 of the casing 50, projections 523 of the elastic support member 52, pressure-sensitive electroconductive members 53, electrode patterns 540 of the substrate 54, and openings 550 of the spacer member 55 to be provided for each operating piece 51 are each changed to one.

Further, in the above embodiment, the operation input device 5 is configured such that the projections 523 of the elastic support member 52, pressure-sensitive electroconductive member 53, electrode patterns 54 of the substrate 54, and openings 550 of the spacer member 55 are provided in one set for each operating piece 51; however, the operation input device 5 may be configured such that the projections 523 of the elastic support member 52, pressure-sensitive electroconductive member 53, electrode patterns 54 of the substrate 54, and openings 550 of the spacer member 55 are provided in multiple sets for each operating piece 51. In this case, the projections 523, pressure-sensitive electroconductive member 53, electrode patterns 540, and openings 550 in each set may be disposed at predetermined intervals in the long side direction of each operating piece 51.

Further, in the above embodiment, the operation input device 5 is used for the electronic musical instrument 1 with which a player plays chords corresponding to the chord designating button group 3 and chord changing button group 4; however, the operation input device 5 may be used for any electronic musical instrument according to another embodiment. For example, the operation input device 5 may be used for an electronic musical instrument having, as an operating part 10 provided in place of the chord designating button group 3 and chord changing button group 4, a plurality of scale sensors corresponding to the frets of a guitar or a bass guitar, or an electronic musical instrument simulating a traditional Japanese musical instrument such as a shamisen or a Taisho harp. Further alternatively, the operation input device 5 may be attached to a casing of an electronic musical instrument having keyboard.

Further, in the above embodiment, the operation input device 5 is used for the electronic musical instrument 1 and configured to input a playing operation; however, the operation input device 5 may be used for electronic devices (mobile devices, game devices, home appliances, on-vehicle devices, medical devices, etc.) other than the electronic musical instrument 1 and configured to function as the operation input device 5 for inputting various operations. In this case, the operation input device 5 may be provided with a plurality of operating pieces or only one operating piece.

Further, in the above embodiment, the playing program 124 is stored in the storage part 12; however, the playing program 124 may be provided by being stored in a computer-readable storage medium such as a CD-ROM, DVD, or the like as a file of an installable format or an executable format. Further, the playing program 124 may be provided by being stored in a server connected to a network such as Internet and downloaded over the network.

1. An operation input device used for an electronic musical instrument comprising:
a casing having a plurality of elongated holes arranged such that long sides thereof have a prescribed interval therebetween;
a plurality of operating pieces respectively inserted in the plurality of elongated holes and held by the casing so as to be operable in a short side direction of each of the elongated holes and the insertion direction in a state in which distal-end side wall surfaces thereof protrude from the casing;
an elastic support member made of an elastic material having a predetermined thickness and having a front surface that supports proximal-end side wall surfaces of the plurality of operating pieces and a back surface on which a plurality of projections are provided in positions corresponding to the proximal-end side wall surfaces of the plurality of operating pieces;
a plurality of pressure-sensitive electroconductive members respectively pressed by the plurality of projections to be elastically deformed;
a substrate having a plurality of electrode patterns respectively contacting the plurality of pressure-sensitive electroconductive members; and
a spacer member disposed between the elastic support member and the substrate and having a plurality of openings arranged so as to avoid the plurality of respective projections.

2. The operation input device according to claim 1, wherein the plurality of projections are provided at positions corresponding respectively to center portions of the proximal-end side wall surfaces of the plurality of operating pieces.

3. The operation input device according to claim 1, wherein the elastic support member has, on the front surface thereof, a plurality of support parts each formed into a pedestal shape and each supporting the proximal-end side wall surface of each of the plurality of operating pieces and a thin part formed around each of the plurality of support parts and having a thickness smaller than that of a portion at which the support part is formed.

4. The operation input device according to claim 1, wherein the plurality of pressure-sensitive electroconductive members are each formed into a strip shape and are each disposed such that the longitudinal direction thereof extends along the short-side direction of the elongated hole so as to stride over the plurality of openings.

5. The operation input device according to claim 1, further comprising an operation detection part that is connected to each of the plurality of electrode patterns and detects a playing operation with respect to each of the plurality of operating pieces based on a change in an electric resistance value occurring when each of the plurality of pressure-sensitive electroconductive members is elastically deformed.

6. The operation input device according to claim 5, wherein the operation detection part converts the electric resistance value into an operation pressure value with respect to the operating pieces, detects the presence/absence of the playing operation when any of the operating pieces is operated in the short side direction in accordance with the length of a first elapsed time from when the operation pressure value falls below a predetermined first upper limit threshold value after exceeding the predetermined first upper limit threshold value until it falls below a predetermined first lower limit threshold value, and detects dynamics in the playing operation in accordance with a first peak value appearing after the operation pressure value exceeds the first upper limit threshold value.

7. The operation input device according to claim 5, wherein the operation detection part converts the electric resistance value into an operation pressure value with respect to the operating pieces, detects the presence/absence of the playing operation when any of the operating pieces is operated in the insertion direction in accordance with the length of a second elapsed time from when the operation pressure value exceeds a predetermined second lower limit threshold value until it exceeds a predetermined second upper limit threshold value, and detects dynamics in the playing operation in accordance with a second peak value appearing after the operation pressure value exceeds the second upper limit threshold value.

8. An operation input device comprising:
a casing having an elongated hole;
an operating piece inserted in the elongated hole and held by the casing so as to be operable in a short side direction of the elongated hole and the insertion direction in a state in which a distal-end side wall surface thereof protrudes from the casing;
an elastic support member made of an elastic material having a predetermined thickness and having a front surface that supports a proximal-end side wall surface of the operating piece and a back surface on which a projection is provided in a position corresponding to the proximal-end side wall surface of the operating piece;
a pressure-sensitive electroconductive member pressed by the projection to be elastically deformed;
a substrate having an electrode pattern contacting the pressure-sensitive electroconductive member; and
a spacer member disposed between the elastic support member and the substrate and having an opening disposed so as to avoid the projection.

9. An electronic musical instrument comprising:
the operation input device as claim 1; and
a sounding part that emits playing sound based on a playing operation with respect to the operation input device.
